(19) United States
(12) Patent Application Publication
(10) Pub. No.: US 2026/0203376 A1
(43) Pub. Date: Jul. 16, 2026

(54) LASER MAINTENANCE APPARATUS AND METHOD

(71) Applicant: Cymer, LLC, San Diego, CA (US)

(72) Inventors: James Michael Simonelli, San Diego, CA (US); Matthew Minakais, San Diego, CA (US); Nathan Gibson Wells, Escondido, CA (US); Christopher James Stevens, Valley Center, CA (US)

(21) Appl. No.: 19/137,156

(22) PCT Filed: Dec. 15, 2023
(86) PCT No.: PCT/IB2023/062819

§ 371 Date: Jun. 9, 2025

Related U.S. Application Data
(60) Provisional application No. 63/434,785, filed on Dec. 22, 2022.

(51) Int. Cl. G06F 18/24; G06N 20/00

(52) U.S. Cl. CPC G06F 18/24; G06N 20/00

(57) ABSTRACT

Disclosed is an apparatus and method in which one or more trained classifiers are used to determine whether to perform an automated containment action and, if an automated containment action is to be performed, which automated containment action is to be performed with less invasive automated containment actions being performed first and more invasive automated containment actions subsequently being performed only of the less invasive automated containment actions are ineffective. Also disclosed is an apparatus and method in which a first data type is used to train a first classifier which is then used to obtain a first classification and then the first classification is used to train a second classifier to classify a second data type.

### CROSS REFERENCE TO RELATED APPLICATIONS

This application claims priority to U.S. Application No. 63/434,785, filed Dec. 22, 2022, titled LASER MAINTENANCE APPARATUS AND METHOD, which is incorporated herein in its entirety by reference.

### TECHNICAL FIELD

The disclosed subject matter relates to an apparatus for and methods of maintenance of laser systems and more specifically to an apparatus for and methods of automated identification of laser system health conditions which may possibly benefit from an automated application of a maintenance containment action.

### BACKGROUND

Laser systems are used, for example, as sources of radiation in facilities that fabricate semiconductor devices, i.e., “fabs.” Laser systems typically require maintenance actions from time-to-time in order to operate in accordance with specifications and avoid manufacturing defects. These maintenance actions include service events in which a Field Service Engineer (FSE) travels to the fab in which the laser system is installed and physically interacts with the laser system. Examples of such service events include troubleshooting, part transactions, calibrations, and alignments.

Callbacks are service events in which the FSE must return to a previously serviced laser system within a set time after an initial service event, e.g., four weeks. Currently, when tool performance is unsatisfactory after a service event, the FSE must travel to and enter the fab and make any required changes manually which can add significant downtime to the downtime incurred in the initial service event. Thus callbacks are highly disfavored by customers. It would be highly advantageous to deploy apparatuses and methods that offer the potential for reducing the number of callbacks or the need for an FSE to interact with the laser system in general. It is in this context that the need for the disclosed subject matter arises.

### SUMMARY

The following presents a succinct summary of one or more embodiments in order to provide an introductory understanding of the presently disclosed subject matter. This summary is not an extensive overview of all contemplated embodiments and is not intended to single out any elements as being key or critical. Nor is it intended to delineate the full scope of any or all embodiments. Its sole purpose is to present some concepts of one or more embodiments in a streamlined form as a prelude to the more detailed description that is presented later.

According to one aspect of an embodiment, there is disclosed an automated maintenance system capable of monitoring performance of a laser system and requesting automated interventions when certain conditions are met. The interventions are referred to as containment actions or simply containments which are actions addressed to restoring within-specification operation. According to another aspect of an embodiment the containments are ranked in terms of invasiveness with less invasive containments being tried first and more invasive containments being performed only if the less invasive containments fail to restore normal operation.

According to another aspect of an embodiment there is disclosed a method of maintaining a laser system, the method comprising using a classifier to determine whether a negative laser condition exists that may be corrected by an automated containment action, selecting as a first automated containment action, a least invasive automated containment action from a group of automated containment actions, performing the first automated containment action, using the classifier to determine whether the negative laser condition has been corrected by performance of the first automated containment action, if the classifier determines that the first automated containment action has not corrected the negative laser condition, then selecting as a next automated containment action a next least invasive containment action from the group of automated containment actions, and performing the next automated containment action.

The group of automated containment actions may comprise N automated containment actions ranked according to invasiveness and the method may additionally comprise sequentially performing ones of the N automated containment actions until either the classifier determines that one of the N automated containment actions has corrected the negative laser condition or that none of the N automated containment actions has corrected the negative laser condition.

According to another aspect of an embodiment, there is disclosed a method of maintaining a laser system, the method comprising training a first classifier using a first data type, using the first classifier to classify first data of the first data type, using the first data to train a second classifier to classify second data of a second data type, using the second classifier to classify the second data and to determine whether to perform an automated containment action, selecting an automated containment action to be performed if the second classifier determines to perform an automated containment action, and performing the automated containment action.

The first data type may comprise data obtained from a gain scan performed by increasing a magnitude of a voltage applied to electrodes in a discharge chamber of the laser system and determining the laser output energy as a function of the magnitude of the voltage. The first data type may comprise data obtained from a timing scan performed by sequentially increasing a time gap between applying a master oscillator trigger voltage to a master oscillator chamber of the laser system and applying a power amplifier trigger voltage to a power amplifier chamber of the laser system to determine variation of an operational parameter as a function of the duration of the time gap. The second data type may comprise burst statistic data. Selecting an automated containment action may comprise selecting a least invasive automated containment action that has not already been performed from a group of automated containment actions.

According to another aspect of an embodiment, there is disclosed a method of maintaining a laser system, the method comprising classifying a first data type using a first classifier to obtain first type classification data, using the first type classification data to train a second classifier to classify a second data type, using the second classifier to determine whether an automated containment action should be performed on the basis of the second classifier classifying the second data type, selecting an automated containment action to be performed if the second classifier determines to perform an automated containment action, and performing the automated containment action.

The first data type may comprise data obtained from a gain scan performed by sequentially increasing a magnitude of a voltage applied to electrodes in a discharge chamber of the laser system and determining the laser output energy as a function of the magnitude of the voltage. The first data type may comprise data obtained from a timing scan performed by sequentially increasing a time gap, between applying a master oscillator trigger voltage to a master oscillator chamber of the laser system and applying a power amplifier trigger voltage to a power amplifier chamber of the laser system, to determine variation of an operational parameter as a function of the duration of the time gap. The second data type may comprise burst statistic data. Selecting an automated containment action may comprise selecting a least invasive automated containment action that has not already been performed, from a group of automated containment actions.

According to another aspect of an embodiment, there is disclosed an apparatus for maintaining a laser system, the apparatus comprising a classifier adapted to determine whether a negative laser condition exists that may be corrected by an automated containment action, an automated containment action selection unit adapted to select as a first automated containment action a least invasive automated containment action from a plurality of automated containment actions, and a first automated containment action performance unit adapted to cause the laser system to perform the first automated containment action, wherein the classifier is further adapted to determine whether the negative laser condition has been corrected by performance of the first automated containment action and, if the negative laser condition has not been corrected by performance of the first automated containment action, to select as a next automated containment action a more invasive automated containment action from the plurality of automated containment actions and wherein the apparatus causes the laser system to perform the second automated containment action if the classifier determines that performance of the first automated containment action has not corrected the negative laser condition.

The plurality of automated containment actions may comprise N automated containment actions ranked according to invasiveness and wherein the apparatus additionally comprises units for respectively performing ones of the N automated containment actions until either the classifier determines that one of the N automated containment actions has corrected the negative laser condition or that none of the N automated containment actions has corrected the negative laser condition.

According to another aspect of an embodiment, there is disclosed an apparatus for maintaining a laser system, the apparatus comprising a first classifier that has been trained using a first data type, second classifier that has been trained using data classified by the first classifier and a second data type, the second classifier being adapted to determine whether to perform an automated containment action, and selector for selecting an automatic containment action to be performed if the second classifier determines to perform an automated containment action.

The first data type may comprise data obtained from a gain scan performed by increasing a magnitude of a voltage applied to electrodes in a discharge chamber of the laser system and determining the laser output energy as a function of the magnitude of the voltage. The first data type may comprise data obtained from a timing scan performed by sequentially increasing a time gap, between applying a master oscillator trigger voltage to a master oscillator chamber of the laser system and applying a power amplifier trigger voltage to a power amplifier chamber of the laser system, to determine variation of an operational parameter as a function of the duration of the time gap. The second data type may be burst statistic data The selector may be adapted to select a least invasive automated containment action that has not already been performed.

According to another aspect of an embodiment, there is disclosed a non-transitory computer-readable medium storing instructions that, when executed by a processor, cause the processor to perform operations, the operations comprising using a classifier to determine whether a negative laser condition exists that may be corrected by an automated containment action, selecting as a first automated containment action a least invasive automated containment action from a plurality of automated containment actions, performing the first automated containment action, using the classifier to determine whether the negative laser condition has been corrected by performance of the first automated containment action, if the classifier determines that the first automated containment action has not corrected the negative laser condition then selecting as a next automated containment action a next least invasive containment action from the plurality of automated containment actions, and performing the next automated containment action.

Further embodiments, features, and advantages of the subject matter of the present disclosure, as well as the structure and operation of the various embodiments, are described in detail below with reference to the accompanying drawings.

### DESCRIPTION OF DRAWINGS

The accompanying drawings, which are incorporated herein and form part of the specification, illustrate the presently disclosed subject matter and, together with the description, further serve to explain the principles of the presently disclosed subject matter and to enable a person skilled in the relevant art to make and use the presently disclosed subject matter.

FIG. 1 is a diagram of a photolithography system such as might benefit from implementation of certain aspects of embodiments.

FIG. 2 is a diagram of a light source for a photolithography system such as might benefit from implementation of certain aspects of embodiments.

FIG. 3 is a functional block diagram of an arrangement for automated maintenance of a laser system in accordance with an aspect of an embodiment.

FIG. 4 is a functional block diagram of an arrangement for training a classifier to be used in an automated maintenance system in accordance with an aspect of an embodiment.

FIG. 5 is a flow chart of a method of automatic maintenance of a laser system in accordance with an aspect of an embodiment.

FIGS. 6A-D are diagrams of a mode of operation of an automated maintenance system in accordance with an aspect of an embodiment.

FIG. 7 is a flow chart of a method of automatic maintenance of a laser system in accordance with an aspect of an embodiment.

FIGS. 8A-C are diagrams of stages of operation of an automated maintenance system in accordance with an aspect of an embodiment.

FIG. 9 is a flow chart of a method of automatic maintenance of a laser system in accordance with an aspect of an embodiment.

FIG. 10 is a functional block diagram of an arrangement for automated maintenance of a laser system in accordance with an aspect of an embodiment.

Further features and advantages of the presently disclosed subject matter, as well as the structure and operation of various embodiments of the presently disclosed subject matter, are described in detail below with reference to the accompanying drawings. It is noted that the scope of this disclosure is not limited to the specific embodiments explicitly described herein. Such embodiments are included herein for illustrative purposes only. Additional embodiments will be apparent to persons skilled in the relevant art based on the teachings presented herein.

### DESCRIPTION

Various embodiments are now described with reference to the drawings, wherein like reference numerals are used to refer to like elements throughout. In the following description, for purposes of explanation, numerous specific details are set forth in order to promote a thorough understanding of one or more embodiments. It may be evident after reviewing this disclosure that in some or all instances any embodiment described below can be practiced without adopting the specific design details described below. In some instances, well-known structures and devices are shown in block diagram form in order to facilitate description of one or more embodiments.

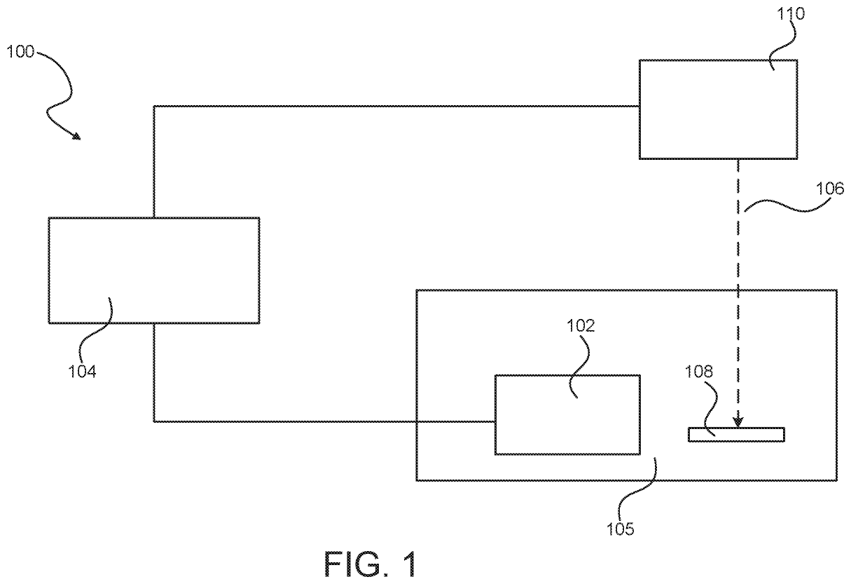

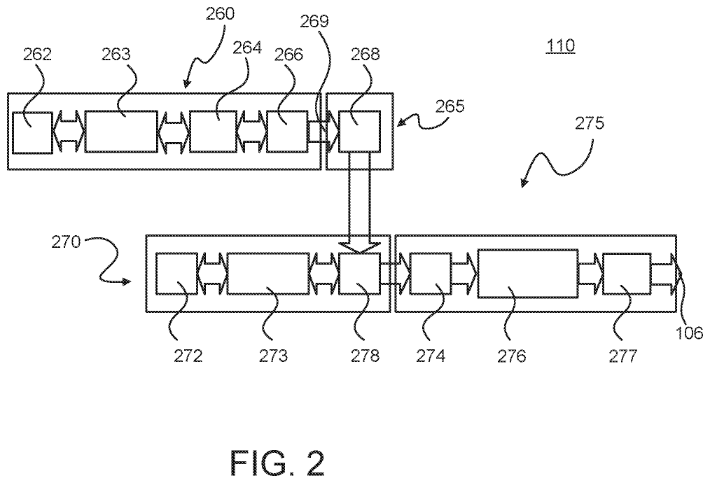

Systems such as those described herein may render benefits in a wide range of applications and implementations. For the sake of having a specific nonlimiting example to facilitate description, one such application is in semiconductor photolithography. Also, the following example is in terms of a system for producing radiation in the deep ultraviolet (DUV) portion of the electromagnetic spectrum that is, light having a wavelength in a range of about 100 nanometers (nm) to about 400 nm. It will be apparent, however, that the principles elucidated herein may also be applied to systems that produce radiation in other portions of the spectrum, for example, the extreme ultraviolet (EUV) portion of the spectrum, that is having a wavelength in a range of about 5 nm to 20 nm, as well as particle beams, such as ion beams or electron beams Referring to FIG. 1, an optical system 100 includes a system controller 104, an output apparatus controller 102, and an illumination system 110 that produces a pulsed laser light beam 106. The light beam 106 may be directed to an output apparatus such as a stepper/scanner 105. The stepper/scanner 105 is a photolithography exposure apparatus that patterns microelectronic features on a wafer 108 using the light beam 106. In a photolithography system, the components within the illumination system 110 (as shown in FIG. 2), will determine the parameters of the light beam 106, and thereby the parameters of the microelectronic features patterned on the wafer 108 by the stepper/scanner 105.

FIG. 2 is a functional block diagram of an example configuration for the illumination system 110. As shown in FIG. 2, the illumination system 110 includes a gas discharge seed laser system 260. The seed laser system 260 is configured to produce a seed laser output pulse from a master oscillator (“MO”) 263. The MO 263 can be configured as a chamber with a pair of electrodes (not shown) such that there is an electrical discharge between the electrodes that causes lasing gas discharge in a lasing gas in the chamber, for example, ArF, KrF, F₂, and/or XeF, that produces relatively broad band radiation.

The resulting broad band radiation can be modified by a line narrowing module (“LNM”) 262 to select a relatively very narrow bandwidth and center wavelength. The LNM 262 may include a grating (not shown). A master oscillator output coupler (“MO OC”) 264 receives radiation from the MO 263. The output of the MO OC 264 may be directed to a line-center analysis module (“LAM”) 266 that produces an output 269.

The output 269 propagates to a relay optics system 265. The relay optics system 265 includes a MO wavefront engineering box (“WEB”) 268 and may include a multi-prism beam expander (not shown) and an optical delay path (not shown). The WEB 268 can be used to redirect the output 269 of the seed laser system 260 to a power amplifier (“PA”) stage 270. The PA may be configured as a power ring amplifier or PRA.

The PA stage 270 includes a beam reverser 272, a PA lasing chamber 273, and a PA WEB 278. The PA WEB 278 is arranged to receive the redirected output 269 of the seed laser system 260 from the MO WEB 268. The PA WEB 278 may include a partially reflective input/output coupler (not shown), a maximally reflective mirror for the nominal operating wavelength, and one or more prisms. The PA WEB 278 may be provided with seed beam injection and output coupling optics (not shown) such that the beam is redirected through a gain medium within the PA lasing chamber 273 by the beam reverser 272.

The PA lasing chamber 273 includes a chamber with a pair of electrodes (not shown). The PA lasing chamber 273 can produce an electrical discharge between the electrodes and thereby produce broad band radiation.

The output of laser light beam pulses from the PA stage 270 is directed by the PA WEB 278 to an output subsystem 275 that measures and modifies the parameters of the laser light beam before producing the final light beam 106. The output subsystem 275 includes a bandwidth analysis module (“BAM”) 274 that receives the output from the PA stage 270 and extracts a portion of the laser light beam pulses for metrology purposes, for example, to measure the bandwidth or pulse energy. The laser light beam pulses are then passed through an optical pulse stretcher (“OPuS”) 276 within the output subsystem 275 to modify the light beam pulses.

The components within the OPUS 276 can be configured to convert a single output pulse into a pulse train. Secondary pulses created from the original single output pulse are delayed with respect to each other such that the effective pulse length of the laser is expanded and the peak pulse intensity is reduced. The resulting light beam from the OPUS 276 is passed through a combined autoshutter metrology module (“CASMM”) 277 or a pulse energy meter within the output subsystem 275 before the light beam 106 is emitted from the illumination system 110.

As mentioned, laser systems such as those just described sometimes require maintenance. Performing such maintenance can incur a significant downtime penalty when an FSE must travel to the fab operating the laser system, take the laser system offline, and manually interact with the system. This downtime penalty can be minimized by a maintenance system that monitors the performance of the laser system and invokes a containment action when one or more predetermined conditions are met. In some embodiments the maintenance system can invoke the containment actions sequentially until invoking a successful containment action. The order in which the maintenance system invokes containment actions may be, for example, in accordance with a predefined parameter such as, for example, invasiveness. Thus the maintenance system starts by invoking the least invasive containment action and progresses to the next most invasive containment action if and only if the least invasive containment action has not restored acceptable operation.

Herein “invasiveness” connotes the burdensomeness of performing the containment action in terms of, for example, monetary cost and/or downtime. Containment actions can range from actions that are less invasive such as conditioning burn-ins (in which chamber conditioning laser pulses are fired) to actions that are more invasive such as refilling the gas in the MO or PA laser chamber, or both.

In some aspects the maintenance system is implemented as one or more machine learning models that use wafer-level-aggregated data to proactively determine when the laser system is in a state in which a containment action is needed, e.g., about to fail, to forestall failure without requiring a callback of field service personnel to the system. When the maintenance system determines the laser system is trending toward/already in a poor state, the maintenance system is empowered to automatically trigger an escalating series of potential solutions, for example, ranging from firing conditioning pulses to changing laser configuration to requesting gas refills.

The maintenance system tracks performance continuously, and if the less-invasive solution tried first is unsuccessful, it chooses from among more invasive potential treatments that it has not yet tried. This prioritizes tool availability and is conservative, leveraging the costliest interventions only as a last resort.

The maintenance system can begin containment instantaneously, independently, and proactively as the laser system performance is descending toward a problem but is not yet sufficiently acute to force downtime. Manual intervention is required only when all of the available automated solutions have failed to restore satisfactory operation. In the worst case where the maintenance system is ultimately unsuccessful in averting an issue, a callback can proceed as it currently would, with the laser system having incurred little to no penalty for trying to avert the callback.

In other words, according to an aspect of an embodiment, the maintenance system is directed to analyzing the state of the laser system and then using a machine learning model to invoke an escalating series of potential solutions, each more invasive. Thus, machine learning is used to decide whether to attempt a potential solution and then, if the decision is to attempt a potential solution, then which of a ranked series of potential solutions to attempt, and to continue this process in rank order until one of the solutions successfully restores satisfactory operation or until all of the potential solutions have been tried unsuccessfully.

In an embodiment, the maintenance system includes a trained classifier to identify states of the laser system requiring attention. A classifier is a machine that categorizes a given set of data into two or more classes or categories. Classifiers may implement any one of a number of classification methods including Logistic Regression, Naive Bayes, Stochastic Gradient Descent, K-Nearest Neighbors, Decision Tree, Random Forest, Artificial Neural Network, and Support Vector Machine. Classification may be binary with categorization into one of two possible classes or may be multi-class with categorization into one of more than two possible classes. A classifier must be trained. Training is the process of taking data that is known to belong to specified classes (truth data or ground truth data) and creating a classifier on the basis of that known data. Classification is the process of taking a classifier built with such a training data set and running the classifier on unknown data to determine class membership for the unknown data.

For example, one example of a classification as it pertains to a laser system is classification into whether the laser system is healthy or unhealthy. One way to judge the health of a laser system, that is, whether the laser system is on the verge of starting to operate in an unsatisfactory manner, is by examining so-called burst statistics data. Systems for obtaining burst statistics are disclosed, for example, in U.S. Patent Application Publication No. 2022/0365445 published Nov. 17, 2022, and titled “Burst Statistics Data Aggregation Filter.”

All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

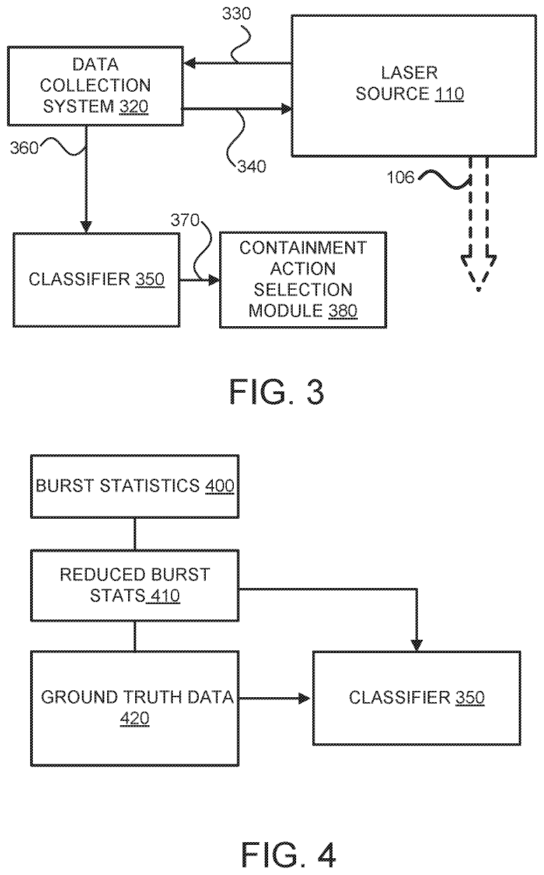

FIG. 3 illustrates a maintenance system according to some embodiments with a data collection and analysis system 320. Data collection and analysis system 320 is configured to receive data 330 from the laser source 110. Additionally or alternatively, data collection and analysis system 320 can send data and/or control information 340 back to laser source 110. The data 330 may include measurements of, for example, beam energy, center wavelength, and bandwidth. The data 330 may also include a repetition rate for the pulses of pulse laser radiation from the laser source 110. These pulses may be emitted in bursts as in the example of FIG. 3. This data will thus be referred to herein as burst statistics data or simply burst statistics.

The raw burst statistics data is received by data collection and analysis system 320 from laser source 110 and represents aggregated pulse-by-pulse wafer level data (e.g., streaming data) associated with laser source 110. These data may be accumulated in terms of minimum values, maximum values, and mean values.

In some examples, data collection and analysis system 320 can be located locally with laser source 110. Additionally, or alternatively, data collection and analysis system 320 can be located at a central location receiving data from one or more laser sources. In some examples, data collection and analysis system 320 can include components that are located locally with laser source 110 and/or are distributed at different geographic places and communicate with each other using one or more networks.

FIG. 3 also includes a classifier 350. The classifier 350 is arranged to receive data 360 from the data collection and analysis system 320 and generate an output 370 indicating whether the laser source 110 is healthy. As used herein, “healthy” refers to a condition of the laser system in which the laser system is operating normally and is neither failing nor on the verge of failing. “Unhealthy” or “negative” refers to a condition of the laser system in which the laser system is either failing or on the verge of failing and a containment action needs to be performed to restore the laser system to a healthy state.

The output 370 is provided to a containment action selection module 380 which determines which automated containment action to perform. As set forth above, according to one aspect of an embodiment, the automated containment action selected may be based on a factor such as degree of invasiveness with a least invasive containment action being selected first and if that does not succeed then successively performing increasingly invasive automated containment actions until one of the containment action succeeds. If none succeeds the maintenance system may call for a nonautomated containment action to be performed manually.

The classifier 350 is trained before it is used. One way the classifier 350 may be trained is by using an ensemble 400 of burst statistics as shown in FIG. 4. The ensemble of burst statistics may be made more tractable by known techniques such as dimensional reduction or feature extraction by a module 410. Dimensional reduction may be performed using any one of a number of known techniques including functional principal component analysis (FPCA).

Also, a collection of ground truth data 420 for the burst statistics is prepared. This collection can be prepared, for example, by expert analysis of a subset of the burst statistics. The size of the ground truth data maybe increased by using known techniques such as bootstrapping (selection with replacement).

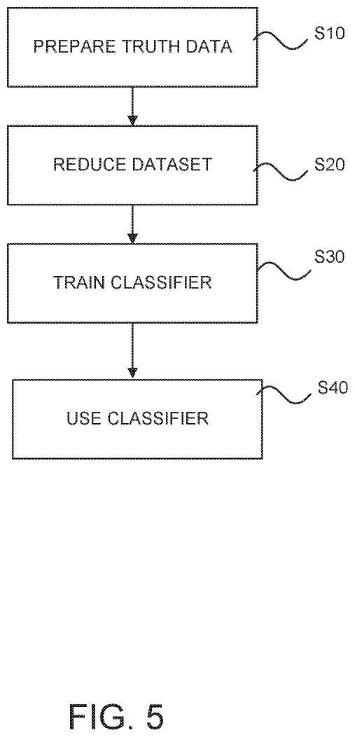

FIG. 5 is a flow chart describing a method of using a classifier to identify laser system conditions requiring containment. In a step S10, truth data is prepared. This step may be carried out, for example, by a hand classification of a subset of the dataset performed by experts. Then, in a step S20, the dataset under consideration, for example, burst statistics, is reduced, for example, by dimensional reduction or feature selection. Then, in a step S30 the classifier is trained by inputting the reduced data set and using the hand classified truth data to train the classifier. Then in a step S40, the trained classifier is used to identify laser system conditions requiring containment.

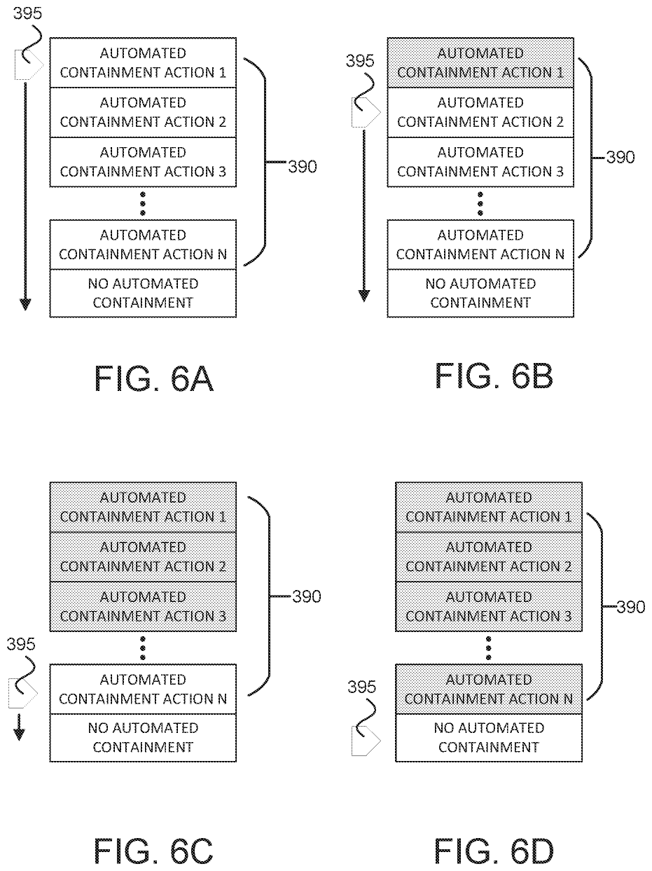

As mentioned, according to an aspect of an embodiment, once it has been determined that the laser system requires performance of a containment action, then which automated containment action to perform can be selected in an iterative process starting with a least invasive automated containment action and continuing in order of increasing invasiveness until an effective automated containment action is performed or it is determined that the system cannot be restored to normal operation with an available automated containment action. For example, in FIG. 6A, there is depicted an array 390 of N automated containment actions, N being a positive integer. The pointer 395 in FIG. 6A is at automated containment action 1. This may be, for example, the least invasive automated containment action. It may, for example, be performing a chamber burn-in by firing pulses to condition the chamber. In FIG. 6B, it is assumed that the automated containment action 1 was ineffective at restoring normal operation for the laser system. The maintenance system then attempts automated containment action 2 which is the next least invasive automated containment action of the N automated containment actions. The shading in the box for automated containment action 1 indicates that this action has been attempted unsuccessfully and will not be attempted again in this example. There may be instances in which an automated containment action may be repeated if it is known that such an automated containment action may be more likely to be effective after a more invasive containment action has been performed.

In FIG. 6C is assumed that all automated containment actions up to automated containment action N, which is the most invasive containment action on the list, is performed. This automated containment action N may correspond, for example, to a refill, which is time consuming and expensive. In FIG. 6D it is determined that even the automated containment action N was ineffective in which case it is determined that an effective automated containment option is not available.

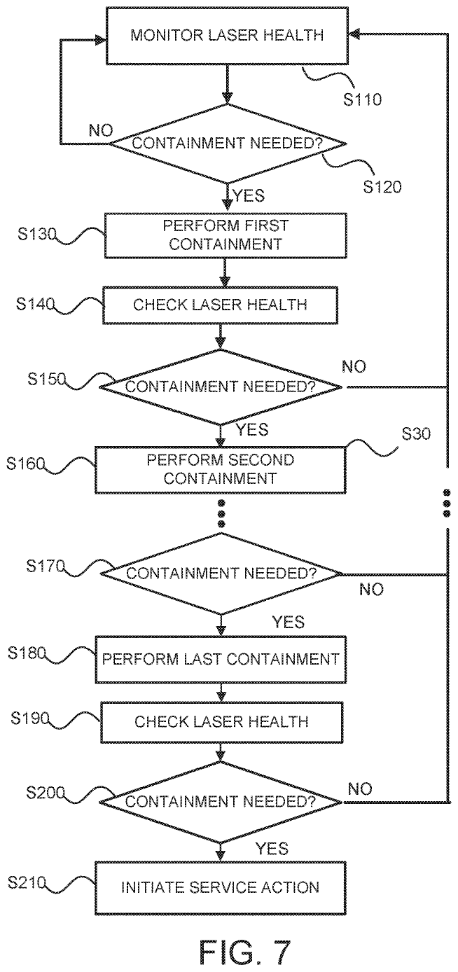

FIG. 7 is a flow chart outlining a procedure for identifying which if any automated containment action to perform according to an aspect of an embodiment. In a step S110 the health of the laser system is monitored. In this context, “laser health” refers to whether the laser is operating outside of acceptable performance limits or is on the verge of doing so. In a step S120 it is determined whether some form of containment action is needed based on the ascertained laser health. If no containment action is needed then the maintenance system simply continues to monitor the laser health continuously in step S110. If, however, a containment action is needed then in a step S130 the maintenance system performs a first automated containment action. As described above, this first automated containment action may be selected from among several automated containment actions ranked according to a certain parameter such as, for example, invasiveness.

After the first automated containment action is performed then in a step S140 the laser health is checked again. Then in a step S150 it is determined whether a containment action is still needed. If no containment action is still needed, then the process reverts to monitoring laser health in step S110. If a containment action is still needed, that is, if the first automated containment action has been ineffective, then in a step S160 a second automated containment action is performed. In the example, this would be the second least invasive containment action, for example, adjusting chamber pressure.

This process continues through step S170 in which a determination is made of whether an ultimate automated containment action is needed. Then, in a step S180 the last available automated containment action is performed. This may be, for example, a most invasive containment action such as a laser chamber gas refill. Then, in a step S190, the laser health is checked again. If it is determined in a step S200 that containment is still needed then it is determined that laser health cannot be restored with an available automated containment action and a service action such as a callback is initiated in a step S210. If, on the other hand, it is determined in step S200 that containment is no longer needed than the process reverts to step S110 to resume continuous monitoring of laser health.

As mentioned, an example of a containment action which can be automated and which is relatively less invasive is firing inoperative pulses in the chamber to condition or burn in the chamber. Here, “inoperative pulses” means pulses that are generated for purposes other than patterning a substrate. An example of a containment action which can be automated and which is relatively more invasive is a gas refill. In a typical laser system, the gas mixture is replaced using a procedure called a refill procedure which includes removing and replacing the gas mixture in the chamber. A refill procedure often consumes (wastes) the expensive gases such as neon making up the gas mixture. Moreover, the laser system cannot be operated during the refill procedure. For at least these reasons, it is desirable to limit the number of refill procedures that are performed. Moreover, it is desirable to perform a refill procedure only when necessary, i.e., when other, less invasive measures have failed.

For some applications it is also desirable that the refill procedure be performed only if the condition the refill procedure is intended to alleviate is one known to be susceptible to correction by refill. For example, a performance condition can include a “MO Rollover,” which refers to the MO moving into a region of operation in which an increase in voltage results in a loss of energy. This can be thought of as a chronic efficiency loss of the MO gas discharge chamber. Typically, the MO Rollover condition is believed to be improved by a refill. Thus, it may be advantageous for some applications to train the maintenance system not only to identify in a binary fashion whether the chamber is healthy or unhealthy but also to train it to recognize which performance condition is causing the chamber to be unhealthy and to select a containment action based on that determination.

Besides a complete refill, other automated containment actions could include adjusting MO or PA chamber gas composition, pressure, temperature, or blower speed. These automated containment actions would constitute containments which are more invasive than firing burn-in pulses but less invasive than complete refills.

For example, one hierarchy of automated containment actions in order of increasing invasiveness may be:
(1) firing conditioning pulses (burn in)
(2) adjust gas pressure
(3) adjust gas temperature
(4) rich refill (adding fluorine gas to the gas mixture in the MO or PA chamber) and
(5) complete refill of either or both of the MO chamber and PA chamber.

It will be appreciated that this order and which measures may be employed may differ according to the characteristics of a given laser system.

The above describes as an example a maintenance system in which burst statistics are used both to train a classifier and then are supplied to the trained classifier to identify unhealthy laser system conditions. The burst statistics, however, have attributes that may impose practical limitations on their usefulness in certain circumstances. One such attribute is the voluminous amount of burst statistics that is available. For example, fabs may send burst statistics to the laser manufacturer for the purposes of monitoring laser system operation for many bursts each being made up of many pulses. The amount of this data may be so large as to be intractable. Also, the burst statistics are obtained from production runs at the fab and so are influenced by contributions from factors which are known solely to the operator of the fab. For example, a fab could be using a process recipe that affects the burst statistics in ways that are unknown to the provider of the laser system. For these reasons, it may be advantageous for some implementations to use a different type of data set as a first data set in conjunction with a second data set being made-up of burst statistics.

For example, another type of data that is available regarding the condition of a laser system is data obtained from one or more scans performed after an automatic gas optimization (AGO) procedure. In an AGO procedure the chamber is overfilled and then used to generate pulses. Then the pressure in the chamber is decreased until the chamber is operating satisfactorily. Then a scan for each of one or more operating parameters is performed.

As an example of one such operating parameter, one figure of merit for a laser system is the laser gain which is how much energy the laser produces as a function of the voltage applied between the electrodes in the laser chambers. This relationship is commonly represented as dv/de, which is the derivative of voltage with respect to energy, or equivalently by its inverse de/dv. Once an AGO procedure has been completed, the FSE may apply an ordered sequence of (scan) electrode voltages and measure laser output energy to obtain a characteristic AGO gain curve. These AGO gain curves can be used to determine whether a system is exhibiting poor or deteriorating performance.

Another type of scan data may be data obtained from a scan performed after an AGO of the time difference (Δt) between (1) when a trigger signal is applied to the MO chamber and (2) when a trigger signal is applied to the PA chamber. This value is known as dtMOPA or AtMOPA. A technician can scan various values of dtMOPA and monitor laser system performance as a function of dtMOPA, for example, bandwidth and center wavelength, to obtain AGO dtMOPA curves. Again, these curves can be related to a system that is in the process of or on the verge of failing, i.e., unhealthy.

Use of the data developed from these scans, referred to herein as AGO data or AGO curve data, has the advantage that it is generated under known conditions and so can be reliably correlated to laser system health. The disadvantage of using these AGO data, however, is that AGO scans generally occur only after a refill so this AGO data is not as voluminous as data obtained from burst statistics.

In accordance with an aspect of an embodiment, these AGO and burst statistic datasets are used together to leverage the benefits of the reliability of AGO data against those of the more readily available burst statistics.

More specifically, in some embodiments AGO data is classified according to the laser system condition (healthy vs. unhealthy) prevailing when the AGO data was acquired. The classified AGO data is then used as truth data for training a burst statistic classifier to classify burst statistics according to laser system condition. The burst statistics for training are correlated with AGO data. As an example, the burst statistic data used to train the burst statistic data classifier may be burst statistic data acquired within a certain time interval of acquisition of the correlated AGO data. This results in a burst statistic data classifier capable of classifying the laser system condition on the basis of input burst statistics.

The preliminary classification of AGO data used to train the burst statistic data classifier can in theory be obtained by having one or more individuals who have in-depth knowledge of laser system behavior (“experts”) relate various instances of burst statistic data to what they judge to be the condition of the laser system at the time the burst statistic data was obtained. This process may be referred to as “hand classification by experts.” Hand classification is time-consuming and labor intensive and so there are practical limits on the amount of data experts can be expected to hand classify. It is in general desirable to have more AGO truth data than can realistically be classified by hand. Thus in some embodiments the AGO data used as truth data to train the burst statistic data classifier is itself obtained by using a preliminary classifier. The preliminary classifier uses a set of hand classified AGO data as truth data to classify input AGO data according to laser system condition. This results in a larger set of classified AGO data which can be used as truth data for the burst statistic data classifier.

In some embodiments the AGO data may be subjected to an FPCA analysis to reduce the AGO data's dimensionality. FPCA ingests the AGO data and returns coefficients for an orthonormal set of basis functions (eigenfunctions) that span the variation of the full dataset. Then a subset of this reduced AGO data may be hand analyzed by experts who correlate the AGO data to machine conditions, i.e., based on probable system state. In one embodiment, the process is binary in the sense that the experts classify the AGO data on the basis of whether the data corresponds to a healthy or unhealthy machine condition. It will be appreciated, however, that this AGO data could also be analyzed with greater granularity on the basis of not solely whether the laser system is healthy or unhealthy but also on the basis of which of one or more specific performance issues are giving rise to an unhealthy state.

The larger set of machine-classified AGO data is then used as truth data to train a second classifier which may be, for example, a Support Vector Classifier (SVC) with a Radial Basis Function (RBF) kernel. Given a set of training examples, each marked as belonging to one of two categories, an SVC builds a model that represents the training data as points in space separated into categories by a gap as wide as possible. New points are then added to space by predicting which category they fall into and which space they will belong to thus assigning new examples to one category or the other. The second classifier thus classifies burst statistics as requiring containment or not requiring containment. The burst statistics may be reduced, for example, by using feature selection in a known manner.

The second classifier once trained can then be used to predict laser system state (as judged by correlated AGO) to classify burst statistics into two cases. The first case is a healthy laser system which is operating according to specification and for which there is no indication that the laser system is in any imminent danger of running out of specification within a certain future time frame. This case does not require that any containment action be performed. The other case is that the laser system is either running out of specification or is likely to be running out of specification within a certain future time frame, that is, unhealthy. This case does require that a containment action be performed. Once this classification has been obtained the maintenance system can try successive automated containment actions as set forth above.

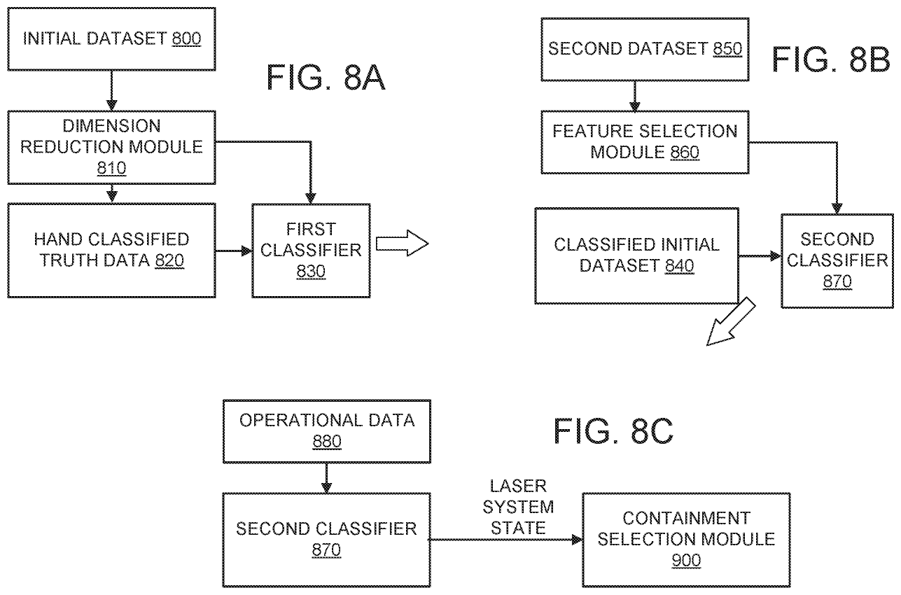

A maintenance process for automatic containment such as that described above is depicted in the functional block diagrams of FIGS. 8A-C. In FIG. 8A, an initial dataset 800, which may be, for example, AGO curve data, is obtained. This initial dataset 800 is provided to a dimension reduction module 810 which reduces the dimension of the first dataset 800 by, for example, performing an FCPA analysis and deriving the coefficients of the eigenfunctions of the first dataset. Some of the reduced initial dataset 800 is hand classified to generate hand classified data 820 that is supplied to a first classifier 830 as truth data. Other portions of the initial dataset 800 are used as inputs to a first classifier 830 which classifies data input from the reduced initial dataset 800 to generate a classified initial dataset 840 (FIG. 8B).

Thus the arrangement of FIG. 8A is used to obtain a classified initial dataset 840 as shown in FIG. 8B. The classified initial dataset 840 is then used to train a second classifier 870 on a second dataset 850 which may be, for example, burst statistics data. The size of the second dataset 850 may be reduced by standard techniques such as feature selection in, for example, a feature selection module 860 as depicted.

Then, as shown in FIG. 8C, the trained second classifier 870 is provided with operational burst statistics data 880 such as information on one or more burst parameters such as gain. The second classifier 870 then provides an indication of laser system state based on the data that has been supplied to it. This laser system state information is supplied to containment selection module 900 which determines which containment automatic containment action should be performed based on the information from the second classifier 870.

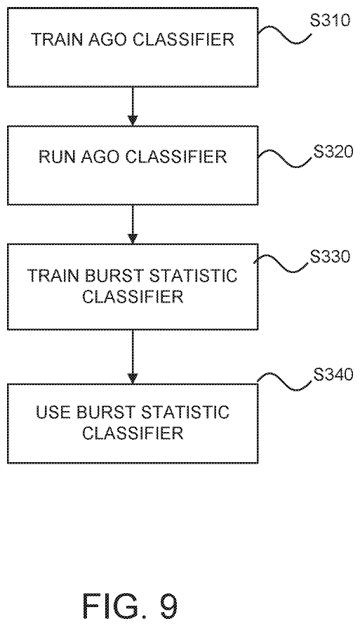

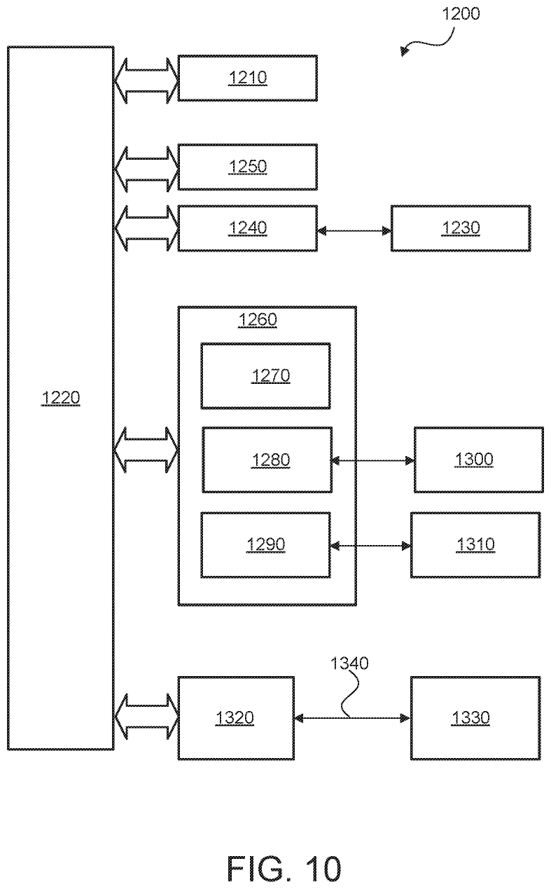

FIG. 9 is a flow chart outlining a process such as might be implemented on the system described above. In a step S310, an AGO classifier is trained using, for example, hand-classified AGO curve data as truth data. Then in a step S320 the trained AGO classifier is operated to obtain a classification of AGO curves according to laser system health. Then, in a step S330, a second classifier, in the example, a burst statistic data classifier, is trained with the input being burst statistic data obtained around (e.g., temporally correlated with) associated AGO data with the output being likely laser system state (healthy vs. unhealthy). The ground truth data is the set of classified AGO data curves produced by the AGO classifier. Then, in a step S340, the burst statistic classifier is used in real time to classify burst statistics and so determine whether or not the laser system is in an unhealthy state, i.e., failing or about to fail.

As shown in FIG. 10, various embodiments and components therein can be implemented, for example, using one or more well-known computer systems, such as, for example, the example embodiments, systems, and/or devices shown in the figures or otherwise discussed. Computer system 1200 can be any well-known computer capable of performing the functions described herein.

Computer system 1200 includes one or more processors (also called central processing units, or CPUs), such as a processor 1210. Processor 1210 is connected to a communication infrastructure or bus 1220.

One or more processors 1210 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 also includes user input/output device(s) 1230, such as monitors, keyboards, pointing devices, etc., that communicate with communication infrastructure 1220 through user input/output interface(s) 1240.

Computer system 1200 also includes a main or primary memory 1250, such as random access memory (RAM). Main memory 1250 may include one or more levels of cache. Main memory 1250 has stored therein control logic (i.e., computer software) and/or data.

Computer system 1200 may also include one or more secondary storage devices or memory 1260. Secondary memory 1260 may include, for example, a hard disk drive 1280 and/or a removable storage device or drive 1290. Removable storage drive 1290 may be a floppy disk drive, a magnetic tape drive, a compact disk drive, an optical storage device, tape backup device, and/or any other storage device/drive.

Removable storage drive 1290 may interact with a removable storage unit 1300. Removable storage unit 1300 includes a computer usable or readable storage device having stored thereon computer software (control logic) and/or data. Removable storage unit 1300 may be a floppy disk, magnetic tape, compact disk, DVD, optical storage disk, and/any other computer data storage device. Removable storage drive 1290 reads from and/or writes to removable storage unit 1300 in a well-known manner.

According to an example embodiment, secondary memory 1260 may include other means, instrumentalities, or other approaches for allowing computer programs and/or other instructions and/or data to be accessed by computer system 1200. Such means, instrumentalities or other approaches may include, for example, a removable storage unit 1310. Examples of the removable storage unit 1310 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1320. Communication interface 1320 enables computer system 1200 to communicate and interact with any combination of remote devices, remote networks, remote entities, etc. (individually and collectively referenced by reference number 1330). For example, communication interface 1320 may allow computer system 1200 to communicate with remote devices 1330 over communications path 1340, which may be wired and/or wireless, and which may include any combination of LANs, WANs, the Internet, etc. Control logic and/or data may be transmitted to and from computer system 1200 via communications path 1340.

In an embodiment, a non-transitory, tangible apparatus or article of manufacture comprising a non-transitory, tangible computer useable or readable medium having control logic (software) stored thereon is also referred to herein as a computer program product or program storage device. This includes, but is not limited to, computer system 1200, main memory 1250, secondary memory 1260, and removable storage units 1290 and 1300, as well as tangible articles of manufacture embodying any combination of the foregoing. Such control logic, when executed by one or more data processing devices (such as computer system 1200), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments may operate with software, hardware, and/or operating system implementations other than those described herein.

Although specific reference may have been made above to the use of embodiments in the context of optical lithography, it will be appreciated that embodiments may be used in other applications, for example imprint lithography, and where the context allows, is not limited to optical lithography.

It is to be understood that the phraseology or terminology herein is for the purpose of description and not of limitation, such that the terminology or phraseology of the present specification is to be interpreted by those skilled in relevant art(s) in light of the teachings herein.

It is to be appreciated that the Detailed Description section is intended to be used to interpret the claims. The Summary and Abstract sections may set forth one or more but not all exemplary contemplated embodiments, and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein.

The above description includes examples of multiple embodiments. It is, of course, not possible to describe every conceivable combination of components or methodologies for purposes of describing the these embodiments, but one of ordinary skill in the art may recognize that many further combinations and permutations of various embodiments are possible. Accordingly, the described embodiments are intended to embrace all such alterations, modifications, and variations that fall within the spirit and scope of the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The implementations can be further described using the following clauses.

1. A method of maintaining a laser system, the method comprising:
using a classifier to determine whether a negative laser condition exists that may be corrected by an automated containment action;
selecting as a first automated containment action, a least invasive automated containment action from a group of automated containment actions;
performing the first automated containment action;
using the classifier to determine whether the negative laser condition has been corrected by performance of the first automated containment action;
if the classifier determines that the first automated containment action has not corrected the negative laser condition, then selecting as a next automated containment action a next least invasive containment action from the group of automated containment actions; and
performing the next automated containment action.

2. The method of clause 1 wherein the group of automated containment actions comprises N automated containment actions ranked according to invasiveness and wherein the method additionally comprises sequentially performing ones of the N automated containment actions until either the classifier determines that one of the N automated containment actions has corrected the negative laser condition or that none of the N automated containment actions has corrected the negative laser condition.

3. A method of maintaining a laser system, the method comprising:
training a first classifier using a first data type;
using the first classifier to classify first data of the first data type;
using the first data to train a second classifier to classify second data of a second data type;
using the second classifier to classify the second data and to determine whether to perform an automated containment action;
selecting an automated containment action to be performed if the second classifier determines to perform an automated containment action; and
performing the automated containment action.

4. The method of clause 3 wherein the first data type comprises data obtained from a gain scan performed by increasing a magnitude of a voltage applied to electrodes in a discharge chamber of the laser system and determining the laser output energy as a function of the magnitude of the voltage.

5. The method of clause 3 wherein the first data type comprises data obtained from a timing scan performed by sequentially increasing a time gap between applying a master oscillator trigger voltage to a master oscillator chamber of the laser system and applying a power amplifier trigger voltage to a power amplifier chamber of the laser system to determine variation of an operational parameter as a function of the duration of the time gap.
6. The method of clause 3 wherein the second data type comprises burst statistic data.
7. The method of clause 3 wherein selecting an automated containment action comprises selecting a least invasive automated containment action that has not already been performed from a group of automated containment actions.
8. A method of maintaining a laser system, the method comprising:
classifying a first data type using a first classifier to obtain first type classification data;
using the first type classification data to train a second classifier to classify a second data type;
using the second classifier to determine whether an automated containment action should be performed on the basis of the second classifier classifying the second data type;
selecting an automated containment action to be performed if the second classifier determines to perform an automated containment action; and
performing the automated containment action.

9. The method of clause 8 wherein the first data type comprises data obtained from a gain scan performed by sequentially increasing a magnitude of a voltage applied to electrodes in a discharge chamber of the laser system and determining the laser output energy as a function of the magnitude of the voltage.

10. The method of clause 8 wherein the first data type comprises data obtained from a timing scan performed by sequentially increasing a time gap, between applying a master oscillator trigger voltage to a master oscillator chamber of the laser system and applying a power amplifier trigger voltage to a power amplifier chamber of the laser system, to determine variation of an operational parameter as a function of the duration of the time gap.

11. The method of clause 8 wherein the second data type comprises burst statistic data.

12. The method of clause 8 wherein selecting an automated containment action comprises selecting a least invasive automated containment action that has not already been performed, from a group of automated containment actions.

13. An apparatus for maintaining a laser system, the apparatus comprising:
a classifier adapted to determine whether a negative laser condition exists that may be corrected by an automated containment action;
an automated containment action selection unit adapted to select as a first automated containment action a least invasive automated containment action from a plurality of automated containment actions; and
a first automated containment action performance unit adapted to cause the laser system to perform the first automated containment action;
wherein the classifier is further adapted to determine whether the negative laser condition has been corrected by performance of the first automated containment action and, if the negative laser condition has not been corrected by performance of the first automated containment action, to select as a next automated containment action a more invasive automated containment action from the plurality of automated containment actions and
wherein the apparatus causes the laser system to perform the second automated containment action if the classifier determines that performance of the first automated containment action has not corrected the negative laser condition.

14. The apparatus of clause 13 wherein the plurality of automated containment actions comprises N automated containment actions ranked according to invasiveness and wherein the apparatus additionally comprises units for respectively performing ones of the N automated containment actions until either the classifier determines that one of the N automated containment actions has corrected the negative laser condition or that none of the N automated containment actions has corrected the negative laser condition.

15. An apparatus for maintaining a laser system, the apparatus comprising:
a first classifier that has been trained using a first data type;
a second classifier that has been trained using data classified by the first classifier and a second data type, the second classifier being adapted to determine whether to perform an automated containment action; and
a selector for selecting an automatic containment action to be performed if the second classifier determines to perform an automated containment action.

16. The apparatus of clause 15 wherein the first data type comprises data obtained from a gain scan performed by increasing a magnitude of a voltage applied to electrodes in a discharge chamber of the laser system and determining the laser output energy as a function of the magnitude of the voltage.

17. The apparatus of clause 15 wherein the first data type comprises data obtained from a timing scan performed by sequentially increasing a time gap, between applying a master oscillator trigger voltage to a master oscillator chamber of the laser system and applying a power amplifier trigger voltage to a power amplifier chamber of the laser system, to determine variation of an operational parameter as a function of the duration of the time gap.

18. The apparatus of clause 15 wherein the second data type comprises burst statistic data.

19. The method of clause 15 wherein the selector is adapted to select a least invasive automated containment action that has not already been performed.

20. A non-transitory computer-readable medium storing instructions that, when executed by a processor, cause the processor to perform operations, the operations comprising:
using a classifier to determine whether a negative laser condition exists that may be corrected by an automated containment action;
selecting as a first automated containment action a least invasive automated containment action from a plurality of automated containment actions;
performing the first automated containment action;
using the classifier to determine whether the negative laser condition has been corrected by performance of the first automated containment action;
if the classifier determines that the first automated containment action has not corrected the negative laser condition then selecting as a next automated containment action a next least invasive containment action from the plurality of automated containment actions; and
performing the next automated containment action.

The above described implementations and other implementations are within the scope of the following claims.

1. A method of maintaining a laser system, the method comprising:
using a classifier to determine whether a negative laser condition exists that may be corrected by an automated containment action;
in response to determining that the negative laser condition exists, selecting as a first automated containment action, a least invasive automated containment action from a group of automated containment actions;
performing the first automated containment action;
using the classifier to determine whether the negative laser condition has been corrected by performance of the first automated containment action;
if the classifier determines that the first automated containment action has not corrected the negative laser condition, then selecting as a next automated containment action a next least invasive containment action from the group of automated containment actions; and
performing the next automated containment action.

2. The method of claim 1 wherein the group of automated containment actions comprises N automated containment actions ranked according to invasiveness and wherein the method additionally comprises sequentially performing ones of the N automated containment actions until either the classifier determines that one of the N automated containment actions has corrected the negative laser condition or that none of the N automated containment actions has corrected the negative laser condition.

3. A method of maintaining a laser system, the method comprising:
training a first classifier using a first data type;
using the first classifier to classify first data of the first data type;
using the first data to train a second classifier to classify second data of a second data type;
using the second classifier to classify the second data and to determine whether to perform an automated containment action;
selecting a selected automated containment action to be performed if the second classifier determines to perform the automated containment action; and
performing the selected automated containment action.

4. The method of claim 3 wherein the first data type comprises data obtained from a gain scan performed by increasing a magnitude of a voltage applied to electrodes in a discharge chamber of the laser system and determining a laser output energy as a function of the magnitude of the voltage.

5. The method of claim 3 wherein the first data type comprises data obtained from a timing scan performed by sequentially increasing a time gap between applying a first trigger voltage to a first chamber of the laser system and applying a second trigger voltage to a second chamber of the laser system to determine variation of an operational parameter as a function of the duration of the time gap.

6. The method of claim 3 wherein the second data type comprises burst statistic data.

7. The method of claim 3 wherein selecting the automated containment action comprises selecting a least invasive automated containment action that has not already been performed from a group of automated containment actions.

8. A method of maintaining a laser system, the method comprising:
classifying a first data type using a first classifier to obtain first type classification data;
using the first type classification data to train a second classifier to classify a second data type;
using the second classifier to determine whether an automated containment action should be performed on the basis of the second classifier classifying the second data type;
selecting a selected automated containment action to be performed if the second classifier determines to perform the automated containment action; and
performing the selected automated containment action.

9. The method of claim 8 wherein the first data type comprises data obtained from a gain scan performed by sequentially increasing a magnitude of a voltage applied to electrodes in a master oscillator discharge chamber of the laser system and determining a laser output energy as a function of the magnitude of the voltage.

10. The method of claim 8 wherein the first data type comprises data obtained from a timing scan performed by sequentially increasing a time gap, between applying a master oscillator trigger voltage to a master oscillator chamber of the laser system and applying a power amplifier trigger voltage to a power amplifier chamber of the laser system, to determine variation of an operational parameter as a function of the duration of the time gap.

11. The method of claim 8 wherein the second data type comprises burst statistic data.

12. The method of claim 8 wherein selecting the selected automated containment action comprises selecting a least invasive automated containment action that has not already been performed, from a group of automated containment actions.

13. An apparatus for maintaining a laser system, the apparatus comprising:
a classifier adapted to determine whether a negative laser condition exists that may be corrected by an automated containment action;
an automated containment action selection unit adapted to select, in response to the classifier determining that the negative laser condition exists, as a first automated containment action a least invasive automated containment action from a plurality of automated containment actions; and
a first automated containment action performance unit adapted to cause the laser system to perform the first automated containment action;
wherein the classifier is further adapted to determine whether the negative laser condition has been corrected by performance of the first automated containment action and, if the negative laser condition has not been corrected by performance of the first automated containment action, to select as a next automated containment action a more invasive automated containment action from the plurality of automated containment actions and
wherein the apparatus causes the laser system to perform the second automated containment action if the classifier determines that performance of the first automated containment action has not corrected the negative laser condition.

14. The apparatus of claim 13 wherein the plurality of automated containment actions comprises N automated containment actions ranked according to invasiveness and wherein the apparatus additionally comprises units for respectively performing ones of the N automated containment actions until either the classifier determines that one of the N automated containment actions has corrected the negative laser condition or that none of the N automated containment actions has corrected the negative laser condition.

15. An apparatus for maintaining a laser system, the apparatus comprising:
a first classifier that has been trained using a first data type;
a second classifier that has been trained using data classified by the first classifier and a second data type, the second classifier being adapted to determine whether to perform an automated containment action; and
a selector for selecting a selected automatic containment action to be performed if the second classifier determines to perform the automated containment action.

16. The apparatus of claim 15 wherein the first data type comprises data obtained from a gain scan performed by increasing a magnitude of a voltage applied to electrodes in a discharge chamber of the laser system and determining a laser output energy as a function of the magnitude of the voltage.

17. The apparatus of claim 15 wherein the first data type comprises data obtained from a timing scan performed by sequentially increasing a time gap, between applying a master oscillator trigger voltage to a master oscillator chamber of the laser system and applying a power amplifier trigger voltage to a power amplifier chamber of the laser system, to determine variation of an operational parameter as a function of the duration of the time gap.

18. The apparatus of claim 15 wherein the second data type comprises burst statistic data.

19. The apparatus of claim 15 wherein the selector is adapted to select as the selected automated containment action a least invasive automated containment action that has not already been performed.

20. (canceled)

21. The apparatus of claim 15, wherein the selector is adapted to select a chamber burn-in by firing pulses to condition the laser system as the selected automated containment action.
